(19) United States
(12) Patent Application Publication
(10) Pub. No.: US 2015/0220919 A1
(43) Pub. Date: Aug. 6, 2015

(54) PAYMENT CARD FRAUD PREVENTION SYSTEM AND METHOD

(71) Applicant: HARRY LYNN WILLIAMS, DALLAS, TX (US)

(72) Inventor: HARRY LYNN WILLIAMS, DALLAS, TX (US)

(21) Appl. No.: 14/169,345

(22) Filed: Jan. 31, 2014

(51) Int. Cl. G06Q 20/40

(52) U.S. Cl. CPC G06Q 20/40

(57) ABSTRACT

Some embodiments include a process to prevent card payment fraud by using a specified duration of time to limit fraudulent card payment activity. In some embodiments, the process uses a timed authorization period which starts prior to a transaction and during which the transaction is to be completed with a payment card.

### BACKGROUND

Embodiments of the invention described in this specification relate generally to fraud prevention, and more particularly, to prevention of payment card-based fraud.

Payment cards, such as bank cards (e.g., ATM cards, debit cards, etc.), credit cards (e.g., general-use credit cards, store-specific credit cards, etc.), prepaid cash cards (e.g., gift cards, store reimbursement cards, etc.), and other such payment cards used in transactions to pay for goods and services, have gone though many iterations of fraud. It seems as soon as the cards were invented, someone was looking for a way to take illegal advantage of the available funds. Credit card security relies on the physical security of the plastic card as well as the protection of the credit card number. However, whenever a person other than the cardholder has access to the card or its number, then security is potentially compromised.

For mail order and electronic purchases, for example, many merchants have completed card payment purchase transactions by merely accepting a credit card number without performing any type of verification. Then, because of excessive fraud, there were ways devised to slow this fraud down. It is now common practice in mail order and electronic card payment transactions to verify the authenticity of the cardholder before completing the transaction. For example, a merchant may check whether the person knows the billing address of the cardholder.

For in-store purchases, many merchants will accept a card number to process payment. However, merely accepting the card number without the card opens the door to fraud. Therefore, most in-store purchases typically require verification of the card's physical presence and a signature of the cardholder. More recently, merchants have required a second layer of verification, for example, by requesting the zip code of the billing address of the card. In theory, this reduces fraud because the billing address zip code is typically the zip code of the authentic cardholder's residence or business. Other examples of verification controls that are currently used include CVC codes, address verification, and zip code processing. Nevertheless, payment card fraud still occurs at excessive rates. When such fraud occurs, it is usually the issuing bank that suffers economic loss, rather than the acquiring bank or cardholder. In addition, while a lost or stolen card can be canceled to prevent or limit the risk of fraud to which a card issuing bank is exposed, the critical factor is the timing in which the card loss is reported, which puts issuing banks in a position of no control.

Therefore, what is needed is a way to prevent fraud via card payment transactions.

### BRIEF DESCRIPTION

Some embodiments of the invention include a novel payment card fraud prevention system and method. In some embodiments, the method uses a timed authorization period which starts prior to a transaction and during which the transaction is to be completed with a payment card.

In some embodiments, the payment card fraud prevention system includes a server, a payee computing device, and a payer computing device. In some embodiments, the payee computing device is a computing device that performs commercial transaction processing. In some embodiments, the payer computing device is a mobile computing device that initiates a commercial transaction.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for using a timed authorization period in which to complete a transaction with a payment card to reduce the occurrence of payment card-based fraud in some embodiments.

FIG. 2 conceptually illustrates a schematic view of an example payment card fraud prevention system in some embodiments.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel payment card fraud prevention system and method. In some embodiments, the method uses a timed authorization period which starts prior to a transaction and during which the transaction is to be completed with a payment card.

As stated above, card payment fraud occurs at levels which banks and financial institutions, who typically end up with losses due to the fraud, would like to reduce. Embodiments described in this specification solve such problem by a method that reduces the time in which a payment card transaction can occur. In some embodiments, the method includes authorizations by the actual card holder and a server for the bank or financial institution in order to complete a transaction. When the transaction is approved, the method of some embodiments saves the transaction in a central repository to allow future transactions without pre-approval.

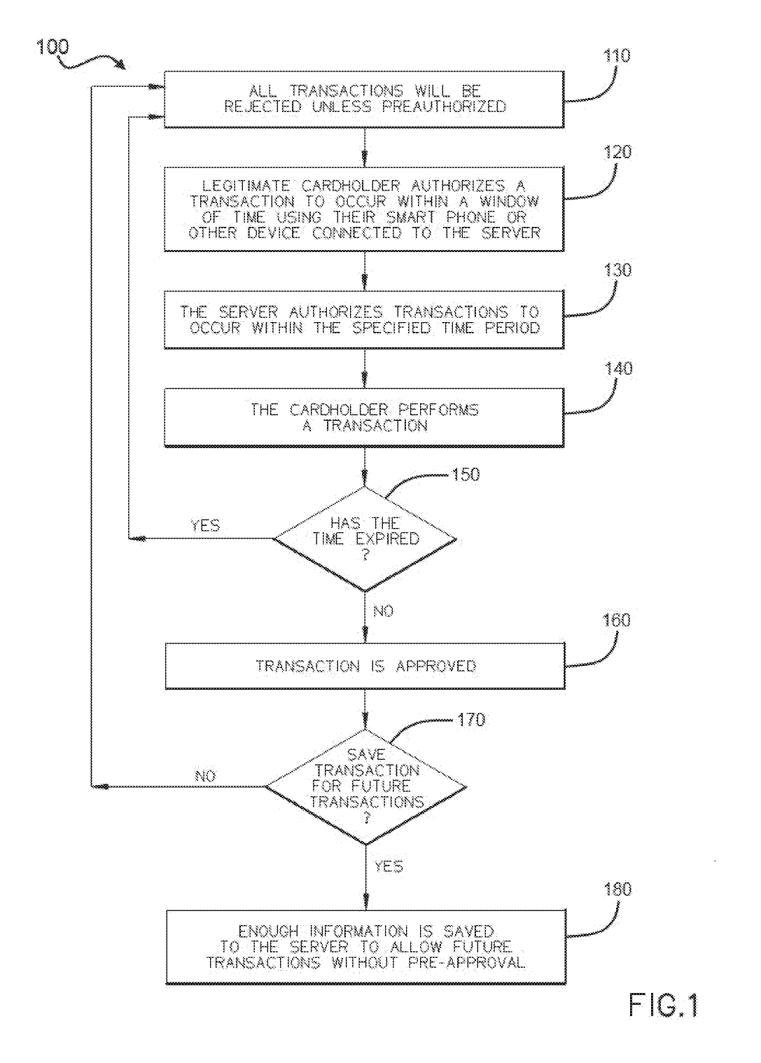

By way of example, FIG. 1 conceptually illustrates a method for using a timed authorization period, right before a transaction in which to complete the transaction with a payment card to reduce the occurrence of payment card-based fraud in some embodiments. As show in this figure, the method 100 starts when a transaction is initiated. The method 100 rejects (at 110) all transactions that are not pre-approved in some embodiments. When a transaction does not have a pre-approval in place to complete the transaction, the cardholder needs to perform operations to obtain the approval. Thus, the method 100 includes (at 120) the ability for the legitimate cardholder to authorize the transaction to occur within a window of time, before the transaction. In some embodiments, the legitimate cardholder authorizes the transaction to occur within the window of time via a mobile computing device that is communicably connected to a central server. The mobile computing device may be, for example, a smart phone, a tablet computing device, etc. The approval for the transaction can come from any computing network device.

Next, the method 100 includes (at 130) the ability for the central server to authorize the transaction to occur within the window of time specified by the legitimate cardholder. For example, the legitimate cardholder may specify a window of time on the order of several minutes (e.g., 10 minutes), and the central server may determine that the specified time is reasonable for completing a transaction, and thereafter authorize the transaction to occur within the window of time as specified. On the other hand, if the cardholder specifies a window of time (e.g., ten years) that would allow fraud to be a greater risk to the bank or financial institution associated with the payment card, then the central repository may deny the authorization.

Once the central server has authorized the transaction to occur within the specified window of time, the method allows (at 140) the cardholder to perform the transaction. As noted above, the cardholder has specified the duration of time in which the transaction can be completed, and the central server has authorized it. Thus, the cardholder will need to be sure the transaction is completed within the specified time. The method 100 therefore checks (at 150) whether the specified time has expired. When the time has expired, the method reverts back to 110, to reject the transaction (which is completed after the specified time) for not having the proper pre-authorization. Note that while the central server has authorized the transaction (i.e., at step 130), the authorization only is in effect for the specified window of time prior or at the time of the financial transaction. At this point, the cardholder may seek to have the pre-authorization specified for a longer window of time.

However, when the transaction is completed and the method 100 determines (at 150) that the time has not expired, then the method transitions to 160 to approve the transaction. After the transaction is approved, in some embodiments the method 100 determines (at 170) whether to save the transaction to use for future transactions. When the method determines that the transaction should not be saved to apply in the future, the method 100 transitions back to 110, which is described above. On the other hand, when the method determines (at 170) that the transaction should be saved, the method saves (at 180) enough information to allow future transactions to be completed without individually-obtained pre-approvals.

In some embodiments, a payment card fraud prevention system allows such common connectivity between different banks and financial institutions. In some embodiments, the payment card fraud prevention system includes a server, a payee computing device, and a payer computing device. In some embodiments, the payee computing device is a computing device that performs commercial transaction processing and the payer computing device is a mobile computing device that initiates a commercial transaction. In some embodiments, the system includes a central repository and a set of computing devices associated with one or both of a set of financial institutions and a set of banks.

The computing devices of the system may include applications related to the following processes. This list of possible related processes is intended to be exemplary only and it is not intended that this list be used to limit the system of the present application to just these related processes. Persons having ordinary skill in the art relevant to the present disclosure may understand there to be equivalent related processes that may be substituted within the present disclosure without changing the essential function or operation of the system.

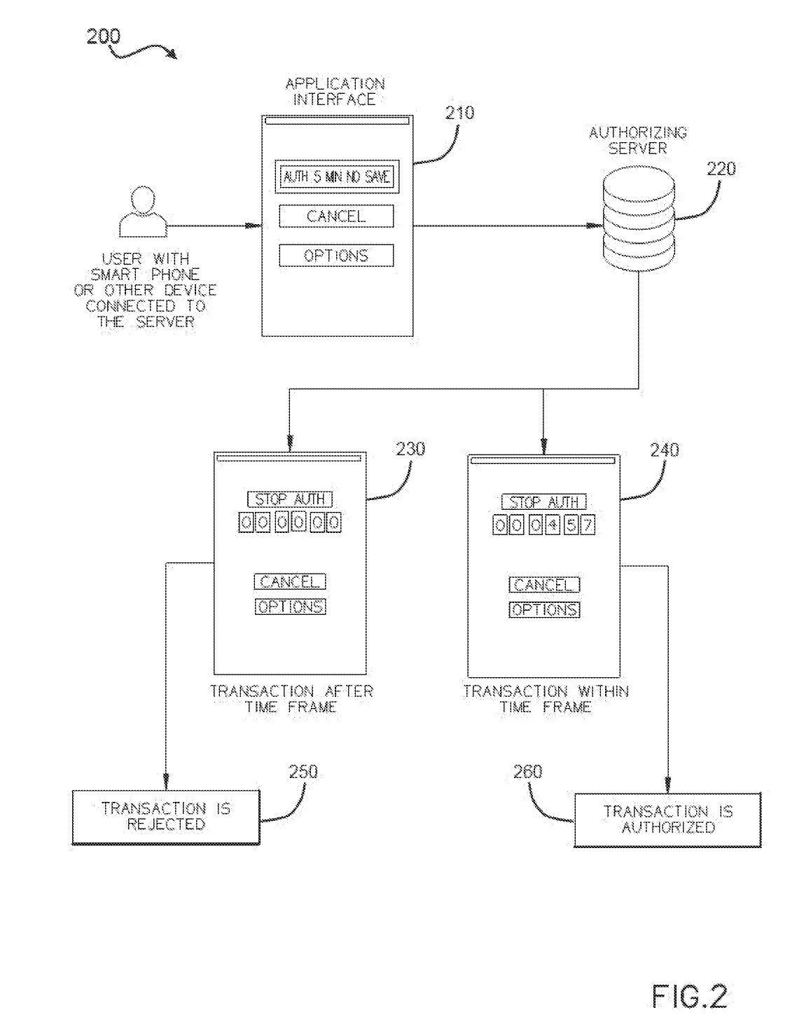

By way of example, FIG. 2 conceptually illustrates a schematic view of an example payment card fraud prevention system in some embodiments. As shown in this figure, a user with a smart phone, other computing device or other mobile computing device seeks to obtain authorization for a transaction through a mobile app, or network app having an interface 210 that allows the user to specify a window of time during which the transaction will be completed. In this example, the user specifies a five minute window of time. The mobile device of the user then transmits the user-specified window of time (i.e., five minutes) to the central authorizing server 220 for approval. When the central server 220 authorizes the user-specified window of time (i.e., five minutes), the task of completing the transaction within the window of time is on the user. When the user fails to complete the transaction within the specified time window, as shown by a first time interface 230, the transaction is rejected at 250. On the other hand, when the user successfully completes the transaction within the specified time window, as shown by a second time interface 240 (i.e., showing time 4:57), the transaction is authorized at 260. In this way, the system attempts to prevent fraud by the agreed time window.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

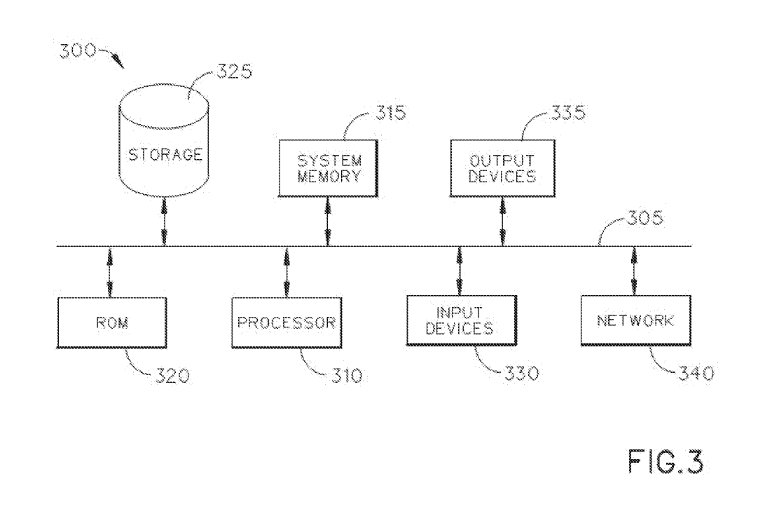

FIG. 3 conceptually illustrates an electronic system 300 with which some embodiments of the invention are implemented. The electronic system 300 may be a computer, phone, PDA, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The bus 305 collectively represents all system, peripheral, and chipset buses that communicatively connect the numerous internal devices of the electronic system 300. For instance, the bus 305 communicatively connects the processing unit(s) 310 with the read-only 320, the system memory 315, and the permanent storage device 325.

From these various memory units, the processing unit(s) 310 retrieves instructions to execute and data to process in order to execute the processes of the invention. The processing unit(s) may be a single processor or a multi-core processor in different embodiments.

The read-only-memory (ROM) 320 stores static data and instructions that are needed by the processing unit(s) 310 and other modules of the electronic system. The permanent storage device 325, on the other hand, is a read-and-write memory device. This device is a non-volatile memory unit that stores instructions and data even when the electronic system 300 is off. Some embodiments of the invention use a mass-storage device (such as a magnetic or optical disk and its corresponding disk drive) as the permanent storage device 325.

Other embodiments use a removable storage device (such as a floppy disk or a flash drive) as the permanent storage device 325. Like the permanent storage device 325, the system memory 315 is a read-and-write memory device. However, unlike storage device 325, the system memory 315 is a volatile read-and-write memory, such as a random access memory. The system memory 315 stores some of the instructions and data that the processor needs at runtime. In some embodiments, the invention's processes are stored in the system memory 315, the permanent storage device 325, and/or the read-only 320. For example, the various memory units include instructions for processing appearance alterations of displayable characters in accordance with some embodiments. From these various memory units, the processing unit(s) 310 retrieves instructions to execute and data to process in order to execute the processes of some embodiments.

The bus 305 also connects to the input and output devices 330 and 335. The input devices enable the user to communicate information and select commands to the electronic system. The input devices 330 include alphanumeric keyboards and pointing devices (also called “cursor control devices”). The output devices 335 display images generated by the electronic system 300. The output devices 335 include printers and display devices, such as cathode ray tubes (CRT) or liquid crystal displays (LCD). Some embodiments include devices such as a touchscreen that functions as both input and output devices.

Finally, as shown in FIG. 3, bus 305 also couples electronic system 300 to a network 340 through a network adapter (not shown). In this manner, the computer can be a part of a network of computers (such as a local area network (“LAN”), a wide area network (“WAN”), or an intranet), or a network of networks (such as the Internet). Any or all components of electronic system 300 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIG. 1. The specific operations of this process may not be performed in the exact order shown and described. Specific operations may not be performed in one continuous series of operations, and different specific operations may be performed in different embodiments. Furthermore, the process could be implemented using several sub-processes, which is conceptually illustrated by way of the example system shown in FIG. 2, or as part of larger macro processes. Thus, one of ordinary skill in the art would understand that the invention is not to be limited by the foregoing illustrative details and examples, but rather is to be defined by the appended claims.

I claim:

1. A non-transitory computer readable medium storing a program which when executed by at least one processing unit of a computing device applies fraud prevention techniques to a transaction, said program comprising sets of instructions for:
receiving a transaction request comprising a specified time window in which a transaction between a consumer and a merchant can be completed;
authorizing the transaction to occur within the specified time window;
receiving a notification that the transaction is completed; and
determining whether the completed transaction occurred within the specified time window; and
sending a response notification comprising only one of an approval of the transaction and a denial of the transaction, wherein the transaction is approved when the completed transaction occurred within the specified time window and the transaction is denied when the completed transaction occurred within a time window that is longer than the specified time window.

2. The non-transitory computer readable medium of claim 1, wherein the response notification comprises the approval, wherein the program further comprises a set of instructions for determining whether to save the approved transaction to use for subsequent transactions.

3. The non-transitory computer readable medium of claim 2, wherein the program further comprises a set of instructions for saving information associated with the approved transaction when the transaction is saved, said transaction information for use in subsequent transactions without prior approval.

4. The non-transitory computer readable medium of claim 2, wherein the program further comprises a set of instructions for rejecting subsequent transactions without prior approval when the approved transaction is not saved.

5. The non-transitory computer readable medium of claim 1, wherein the transaction request further comprises a specified transaction saving preference comprising only one of save and no save.

6. The non-transitory computer readable medium of claim 1, wherein the transaction request is received from a mobile computing device of the consumer.
